(19) United States
(12) Patent Application Publication
(10) Pub. No.: US 2025/0062687 A1
(43) Pub. Date: Feb. 20, 2025

(54) CHARGE PUMP STABILITY CONTROL

(71) Applicant: pSemi Corporation, San Diego, CA (US)

(72) Inventors: Aichen Low, Cambridge, MA (US); Gregory Szczeszynski, Nashua, NH (US); David Giuliano, Bedford, NH (US)

(21) Appl. No.: 18/815,798

(22) Filed: Aug. 26, 2024

Related U.S. Application Data
(63) Continuation of application No. 18/458,750, filed on Aug. 30, 2023, now Pat. No. 12,074,515.
Application No. 18/458,750 is a continuation of application No. 17/936,406, filed on Sep. 29, 2022, now Pat. No. 11,784,561.
Application No. 17/936,406 is a continuation of application No. 17/307,921, filed on May 4, 2021, now Pat. No. 11,496,046.
Application No. 17/307,921 is a continuation of application No. 16/658,570, filed on Oct. 21, 2019, now Pat. No. 11,031,864.
Application No. 16/658,570 is a continuation of application No. 16/037,362, filed on Jul. 17, 2018, now Pat. No. 10,454,368.
Application No. 16/037,362 is a continuation of application No. 15/850,117, filed on Dec. 21, 2017, now Pat. No. 10,027,224.
Application No. 15/850,117 is a continuation of application No. 15/126,073, filed on Sep. 14, 2016, now Pat. No. 9,887,622.
(60) Provisional application No. 61/953,303, filed on Mar. 14, 2014.
(60) Provisional application No. 61/953,270, filed on Mar. 14, 2014.

(51) Int. Cl. H02M 3/07

(52) U.S. Cl. CPC H02M 3/07; H02M 3/073

(57) ABSTRACT

An apparatus for power conversion includes a switching network that controls interconnections between pump capacitors in a capacitor network that has a terminal coupled to a current source, and a charge-management subsystem. In operation, the switching network causes the capacitor network to execute charge-pump operating cycles during each of which the capacitor network adopts different configurations in response to different configurations of the switching network. At the start of a first charge-pump operating cycle, each pump capacitor assumes a corresponding initial state. The charge-management subsystem restores each pump capacitor to the initial state by the start of a second charge-pump operating cycle that follows the first charge-pump operating cycle.

### RELATED APPLICATIONS

This application is a continuation of U.S. application Ser. No. 18/458,750, filed on Aug. 30, 2023, which under 35 USC 120 is a continuation of U.S. application Ser. No. 17/936,406, filed on Sep. 29, 2022, now U.S. Pat. No. 11,784,561, issued on Oct. 10, 2023, which is a continuation of U.S. application Ser. No. 17/307,921 filed May 4, 2021, now U.S. Pat. No. 11,496,046, issued on Nov. 8, 2022, which is a continuation of U.S. application Ser. No. 16/658,570 filed Oct. 21, 2019. now U.S. Pat. No. 11,031,861, issued on Jun. 8, 2021, which is a continuation of U.S. application Ser. No. 16/037,362, filed on Jul. 17, 2018, now U.S. U.S. Pat. No. 10,454,368, issued on Oct. 22, 2019, which is a continuation of U.S. application Ser. No. 15/850,117, filed on Dec. 21, 2017, now U.S. Pat. No. 10,027,224, issued on Jul. 17, 2018, which is a continuation of U.S. application Ser. No. 15/126,073, filed on Sep. 14, 2016, now U.S. Pat. No. 9,887,622, issued on Feb. 6, 2018, which is the national phase under 35 USC 371 of International Application No. PCT/US2015/019860, filed on Mar. 11, 2015 which under 35 USC 119, claims the benefit of the Mar. 14, 2014 priority date of U.S. Provisional Application 61/953,303 and the Mar. 14, 2014 priority date of U.S. Provisional Application 61/953,270, the contents of which are herein incorporated by reference.

### FIELD OF DISCLOSURE

This invention relates to power converters, and in particular, to charge pumps.

### BACKGROUND

In many circuits, the power that is available to drive the circuit may not be in a form that the circuit demands. To correct this, it is useful to provide a power converter that converts the available power into a form that conforms to the circuit's requirements.

One common type of power converter is a switch-mode power converter. A switch-mode power converter produces an output voltage by switching reactive circuit elements into different electrical configurations using a switch network. A switched capacitor power converter is a type of switch-mode power converter that primarily utilizes capacitors to transfer energy. Such converters are called “charge pumps.” The capacitors are called “pump capacitors.”

In operation, a charge pump transitions from one pump-state to the next in a sequence of pump-states. Each pump-state is characterized by a residence time in which the charge pump remains in that pump-state, and transition times, in which the charge pump is between pump-states. The sum of the residence times for all pump-states and the intervening transition times between those pump-states is the period for one cycle of the charge pump.

For correct operation, each pump capacitor should begin and end each cycle with zero change in charge. If this is not the case, charge will accumulate on the pump capacitor over the course of several cycles in the case of positive non-zero change in charge. Since the voltage across a capacitor is linearly proportional to the charge, this charge accretion/depletion will cause the voltage across the pump capacitor to drift over time.

In many charge pumps, a switch connects adjacent pump capacitors. The voltage across the switch thus depends on the voltages across adjacent pump capacitors. If voltages across these capacitors drift unevenly, the voltage across the switch may exceed its rating. This may cause the switch to overheat, thus destroying the switch, and the charge pump as well.

Procedures for managing charge on a pump capacitor depend in part on how the charge got there. In general, there are two ways to put charge into a capacitor: using a voltage source, or using a current source.

When a voltage source is used, management of charge is relatively simple. The charge present at a capacitor is a linear function of the voltage. Thus, dropping the voltage to zero is sufficient to remove the charge from the capacitor.

When a current source is used, management of charge is not so simple. This is because the charge on a pump capacitor is related to an integral of the current, and not to the instantaneous value of current.

On Nov. 8, 2012, Patent Publication WO 2012/151466, which is incorporated herein by reference, made public configurations of charge pumps in which one terminal was connected to a regulator. Because of its inductor, and because of the relevant time scales associated with the switches involved, as far as these charge pump configurations are concerned, the regulator behaved like a current source. This made management of how much charge is in the pump capacitors more challenging.

### SUMMARY

The inventive subject matter described herein relates to stabilizing a charge pump coupled with a current source or load by ensuring that each pump capacitor of the charge pump begins a cycle in the same condition for every cycle. This avoids charge accretion that occurs when residual charge from the end of a first cycle is added to the beginning of a second cycle, thus causing the voltage of the capacitor to drift over time.

In one aspect, the invention features an apparatus for power conversion. Such an apparatus includes a switching network, and a charge management subsystem. The switching network controls interconnections between pump capacitors in a capacitor network that has a terminal coupled to a current source. In operation, the switching network causes the capacitor network to execute charge-pump operating cycles during each of which the capacitor network adopts different configurations in response to different configurations of the switching network. At the start of a first charge-pump operating cycle, each pump capacitor assumes a corresponding initial state. The charge-management subsystem restores each pump capacitor to the initial state by the start of a second charge-pump operating cycle that follows the first charge-pump operating cycle.

In some embodiments, a controller in the charge-management subsystem controls residence time. One such embodiment features a controller that controls a first residence time during which the switching network is in a first configuration. Another embodiment features a controller that controls a first residence time during which the switching network is in a first configuration, and a second residence time during which the switching network is in a second configuration. Also included are embodiments in which the controller causes the switching network to cause the capacitor network to assume a dead-time configuration.

In some embodiments, a cycle includes a first configuration and a second configuration, and a controller of the charge-management subsystem controls a second configuration of the switching network based on a result of having had the switching network assume the first configuration. In other embodiments, the switching network passes through a present cycle and at least one past cycle, and the controller controls the present cycle based at least in part on performance of the switching network during at least one of the past cycles. In yet other embodiments, the switching network passes through a present cycle after having passed through past cycles, and the charge-management subsystem includes a proportional-integral-derivative controller that controls the present cycle based at least in part on performance of the switching network during at least one of the past cycles.

Embodiments also include those in which the charge-management system includes a controller configured to exercise control over configurations of the switching network. Among these are embodiments in which the controller includes a feedback controller configured to control the different configurations of the switching network based on an output of the capacitor network, and those in which the controller includes a threshold-logic circuit controller configured to control the different configurations of the switching network based on an output of the capacitor network.

Yet other embodiments do not rely on controlling the switching network. In one such embodiment, the charge-management system includes a controller configured to exercise control over the current source to which the capacitor network is coupled. Among these embodiments are those in which the capacitor network has two terminals, one of which is a low-voltage terminal, and the terminal that is coupled to the current source is a low-voltage terminal. Also among these embodiments is the converse case, in which the capacitor network has two terminals, one of which is a high-voltage terminal, and the terminal that is coupled to the current source is a high-voltage terminal.

In some embodiments, the charge-management system includes a stabilizing capacitance connected to the current source.

Other embodiments include a trim-capacitor network that includes switches that are selectively configured to define an interconnection of one or more trim capacitors, thereby defining an aggregate capacitance that reduces a mismatch between the aggregate capacitance and a desired capacitance. In some of these embodiments, the desired capacitance is a stabilizing capacitance connected to the current source. In others, the desired capacitance is a desired capacitance of a pump capacitor.

Embodiments also include those in which the charge-pump operating cycle has a constant time duration, and those in which the charge-pump operating cycle has a variable time duration.

In some embodiments, the second charge-pump operating cycle that follows the first charge-pump operating cycle is a charge-pump cycle that immediately follows the first charge-pump operating cycle. However, in some cases, complete restoration cannot be done in one cycle. Thus, in certain embodiments, the second charge-pump operating cycle that follows the first charge-pump operating cycle is a charge-pump cycle that is separated from the first charge-pump operating cycle by at least one intervening charge-pump operating cycle.

The invention also includes embodiments that include the capacitor network that the switching network is configured to control.

Embodiments of the invention also include those in which the switching network causes execution of a charge pump operating cycle that consists of no more than two configurations during which transfer of charge between capacitors occurs, as well as those in which switching network causes execution of a charge pump operating cycle that consists of at least three configurations during which transfer of charge between capacitors occurs.

In some embodiments, the capacitor network and the switching network define a charge pump. Among these are embodiments in which the charge pump includes a multi-stage charge pump, embodiments in which the charge pump includes a cascade multiplier, embodiments in which the charge pump includes a multi-phase charge pump, and embodiments in which the charge pump includes a single-phase charge pump.

A variety of devices function as current sources within the meaning of the invention. One such device is a regulator. Among the regulators that function as current sources are switch-mode power converters, and buck converters.

In some embodiments, the charge management subsystem restores at least one of the pump capacitors to an initial state thereof at least in part by changing an amount of charge stored on the at least one pump capacitor. Among these embodiments are those in which the charge management subsystem changes an amount of charge stored one the pump capacitor by causing flow between that pump capacitor and a repository of charge. Suitable repositories include another pump capacitor or ground.

In another aspect, the invention features a method for controlling a charge pump. Such a method includes causing a charge-pump switching network to cause a network of pump capacitors to which the charge pump switching network is coupled to execute charge-pump operating cycles during each of which the network of pump capacitors adopts different configurations in response to different configurations of the switching network. At the start of a first charge-pump operating cycle, each pump capacitor assumes a corresponding initial state. The method then proceeds by restoring each pump capacitor to the initial state by the start of a second charge-pump operating cycle that follows the first charge-pump operating cycle.

In some practices, restoring each pump capacitor to the initial state includes restoring each pump capacitor to the initial state by the start of a second charge-pump operating cycle that immediately follows the first charge-pump operating cycle. However, there are also practices of the invention in which restoring each pump capacitor to the initial state includes restoring each pump capacitor to the initial state by the start of a second charge-pump operating cycle that is separated from the first charge-pump operating cycle by at least one charge-pump operating cycle.

Some practices restore each pump capacitor to the initial state by controlling residence time. One such practice includes controlling a first residence time during which the switching network is in a first configuration. However, in another practice, restoring each pump capacitor to the initial state includes controlling a first residence time during which the switching network is in a first configuration, and also controlling a second residence time during which the switching network is in a second configuration. Yet other practices include controlling residence times for additional configurations, some of which involve charge transfer and some of which do not. For example, in one practice, restoring each pump capacitor to the initial state includes causing the capacitor network to assume a dead-time configuration.

Practices also include those in which a cycle includes a first configuration and a second configuration, and restoring each pump capacitor to the initial state includes controlling a second configuration of the switching network based on a result of having had the switching network assume a first configuration.

In other practices, the switching network passes through a present cycle and at least one past cycle, and restoring each pump capacitor to the initial state includes controlling the present cycle based at least in part on performance of the switching network during the at least one past cycle.

In yet other practices, the switching network passes through a present cycle after having passed through past cycles, and restoring each pump capacitor to the initial state includes implementing proportional-integral-derivative control over the present cycle based at least in part on performance of the switching network during at least one of the past cycles.

Some practices of the invention are those in which restoring each pump capacitor to the initial state includes exercising control over configurations of the switching network. Among these are practices in which exercising control over configurations of the switching network includes exercising feedback control of the different configurations of the switching network based on an output of the capacitor network, and those in which exercising control over configurations of the switching network includes exercising threshold-logic control over the different configurations of the switching network based on an output of the capacitor network.

In yet other practices, restoration of each pump capacitor to the initial state includes exercising control over a current source to which the capacitor network is coupled. Among these practices are those that include exercising control over a current source that is coupled to a low-voltage terminal, and those that include exercising control over a current source that is coupled to a high-voltage terminal.

Yet other practices are those in which restoring each pump capacitor to the initial state includes connecting a stabilizing capacitance connected to the current source.

Other practices include those in which restoring each pump capacitor to the initial state includes interconnecting one or more trim capacitors to define an aggregate capacitance that minimizes an error between the aggregate capacitance and a desired capacitance. Examples of a desired capacitance include a desired capacitance of a stabilizing capacitor connected to a current source, and a desired capacitance of a pump capacitor.

In other practices, causing a charge-pump switching network to cause a network of pump capacitors to which the charge pump switching network is coupled to execute charge-pump operating cycles includes causing execution of charge-pump operating cycles having a constant time duration. However, in other practices, the time duration is variable.

Some practices feature starting the second charge-pump operating cycle that follows the first charge-pump operating cycle immediately after finishing the first charge-pump operating cycle. However, in other practices, starting the second charge-pump operating cycle that follows the first charge-pump operating cycle occurs only after having finished at least one intervening charge-pump operating cycle.

In some practices, causing a charge-pump switching network to cause a network of pump capacitors to which the charge pump switching network is coupled to execute charge-pump operating cycles includes causing execution of a charge pump operating cycle that consists of no more than two configurations during which transfer of charge between capacitors occurs. However, in others, this is carried out instead by causing execution of a charge pump operating cycle that consists of at least three configurations during which transfer of charge between capacitors occurs.

Certain practices include forming a charge pump by combining the capacitor network and the switching network Among these are practices in which the charge pump thus formed is a multi-stage charge pump. However, other charge pumps, such as a cascade multiplier, a multi-phase charge pump, or a single-phase charge pump, can also be formed.

In some practices, exercising control over a current source to which the capacitor network is coupled includes exercising control over a regulator. This can include exercising control over many different kinds of regulators, all of which effectively function as current sources. Such regulators include switch-mode power converters, and buck converters.

Other practices are those in which restoring each pump capacitor to the initial state includes restoring at least one of the pump capacitors to an initial state thereof at least in part by changing an amount of charge stored on the at least one pump capacitor. Practices of this kind can include causing flow between the at least one pump capacitor and a repository of charge. Examples of a suitable repository include another pump capacitor, or ground.

One effect of using a current-based load (or source) with a charge pump is that there may be situations when fixed switch timing used with current-based loads and/or sources results in charge imbalance across capacitors. Such imbalance can result in (or can co-occur with) larger than necessary ripple, extremes in voltage and/or current internal to or at terminals of the charge pump, drift in average and/or peak voltages internal or at terminals of the charge pump, and/or instability, which may be manifested by growing amplitude of voltage variation between points internal to and/or terminals of the charge pump.

In another aspect, in general, an approach to avoiding and/or mitigating the effects related to charge imbalance is by adjusting the switch timing in a feedback arrangement. In some examples, a pattern of switch timing is adapted based on electrical measurements at the terminals and/or internal to the charge pump. In some examples, the instants of transition of switch states are determined by such electrical measurements.

One effect of using a current-based load (and/or source) with a charge pump is that there may be situations in which a conventional switch timing used with voltage-based loads and/or sources results in charge imbalance across capacitors, which can result in loss of efficiency, for example, due to charge redistribution immediately after switching between configurations in the charge pump.

In one aspect, in general, an approach to improving efficiency of a charge pump using adiabatic charge transfer makes use of three or more states, each corresponding to a configuration of switches coupling capacitors to one another and/or the input and output terminals of the charge pump. By introducing an appropriate sequence of more than two states in which charge is transferred to or from capacitors, and selecting the duration those states are occupied in each operating cycle of the charge pump, charge transfer in and out of each capacitor is balanced over the operating cycle, thereby avoiding or greatly reducing charge redistribution at state transitions and its associated power losses that lead to inefficiency.

These and other features of the invention will be apparent from the following detailed description, and the accompanying drawings, in which:

### BRIEF DESCRIPTION OF THE DRAWINGS

FIG. 1 shows a single-phase charge pump;

FIG. 2 shows a time-line associated with the operation of the single-phase charge pump of FIG. 1;

FIG. 3 shows circuit configurations associated with a cycle of the single-phase charge pump of FIG. 1;

FIG. 4 shows a two-phase charge pump;

FIG. 5 shows circuit configurations associated with a cycle of the two-phase charge pump of FIG. 4;

FIG. 6 shows a first controller for controlling pump-state residence times in the charge pump of FIG. 1;

FIG. 7 shows a second controller for controlling pump-state residence times in the charge pump of FIG. 1:

FIG. 8 shows an implementation of the second feedback circuit in FIG. 7;

FIG. 9 shows an implementation of the second timing circuit in FIG. 7;

FIG. 10 shows a third controller for controlling pump-state residence times in the charge pump of FIG. 1;

FIG. 11 shows a fourth controller for controlling current at a load;

FIG. 12 shows a fifth controller for controlling current at a regulator;

FIG. 13 shows a switching network for attaining a desired capacitance for a pump capacitor in FIG. 1;

FIG. 14 shows a switching network for attaining a desired stabilization capacitance;

FIG. 15 is a schematic diagram of a single-phase 5:1 charge pump with a voltage source and a current load;

FIGS. 16A and 16B are schematic diagrams of the circuit of FIG. 15 in states 1 and 2, respectively, of the switch configuration;

FIGS. 17A-17C are schematic diagrams of the circuit of FIG. 15 in states 1a, 1b, and 2, respectively;

FIGS. 18A-18C are schematic diagrams of the circuit of FIG. 15 in alternative definitions of states 1a, 1b, and 2, respectively;

FIG. 19 is a schematic diagram of a single-phase 6:1 charge pump with a voltage source and a current load;

FIGS. 20A-20D are schematic diagrams of the circuit of FIG. 19 in states 1a, 1b, and 2, respectively;

FIG. 21 is a schematic diagram of a two-phase 5:1 charge pump with a voltage source and a current load;

FIGS. 22A-22B are schematic diagrams of the circuit of FIG. 21 in states 1a and 1b, respectively;

FIG. 23 is a schematic of a two-phase 3:1 series-parallel charge pump with a voltage source and a current load;

FIGS. 24A-24D are schematic diagrams of the circuit of FIG. 23 in states 1a, 1b, 2a, and 2b, respectively; and

FIG. 25 is a block diagram of a power control system.

### DETAILED DESCRIPTION

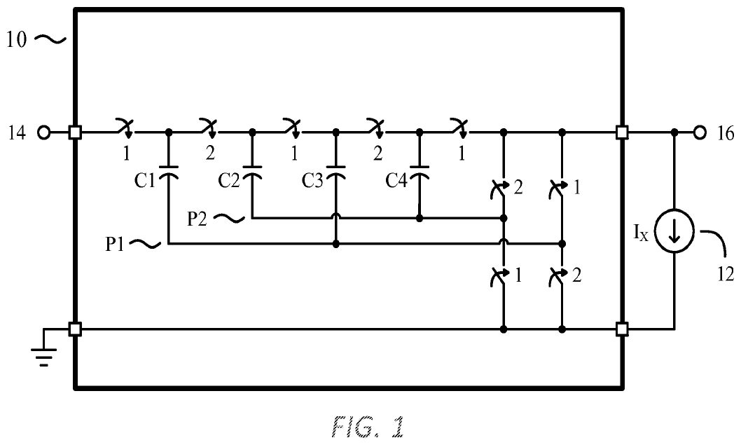

FIG. 1 shows a first example of a charge pump 10 coupled to a load 12 that is modeled as an ideal current source. The charge pump 10 is a multi-stage charge pump, also known as a cascade multiplier. Although the current shown is actually being drawn from the charge pump 10, this distinction amounts to a mere sign change. The important feature of a current source is that it relentlessly drives a constant flow of current.

Throughout this specification, reference will be made to a “current source.” As is well known, an ideal “current source” is an abstraction used for circuit analysis that does not in fact exist. However, for the time scales of interest, there are a variety of devices that effectively function as a current source. Examples include regulators, such as linear regulators, DC motors, depending on the load, and an IDAC, which is an active circuit that sets the current through LEDs. Thus, throughout this specification, “current source” or “current load” is understood to mean real devices, including but not limited to those enumerated herein, that effectively function as a current source.

The load 12 can be viewed as a non-zero constant current, or a pulsed current that alternates between two values, one of which can be zero. Charge transfer occurs whenever the current at the load is non-zero. When the current is non-zero and constant, the charge transfer will be referred to as “soft charging,” or “adiabatic charging.”

The charge pump 10 has first and second terminals 14, 16. One terminal is a high voltage that carries a low current. The other terminal is a low voltage that carries a high current. In the particular example described herein, the second terminal 16 is the low voltage terminal. However, in other embodiments, the second terminal 16 is the high voltage terminal.

Between the terminals 14, 16 are four identical pump capacitors: outer pump capacitors C1, C4 and inner pump capacitors C2, C3. A first phase-node P1 couples with the negative terminal of the first and third pump capacitors C1, C3, and a second phase-node P2 couples with the negative terminal of the second and fourth pump capacitors C2, C4.

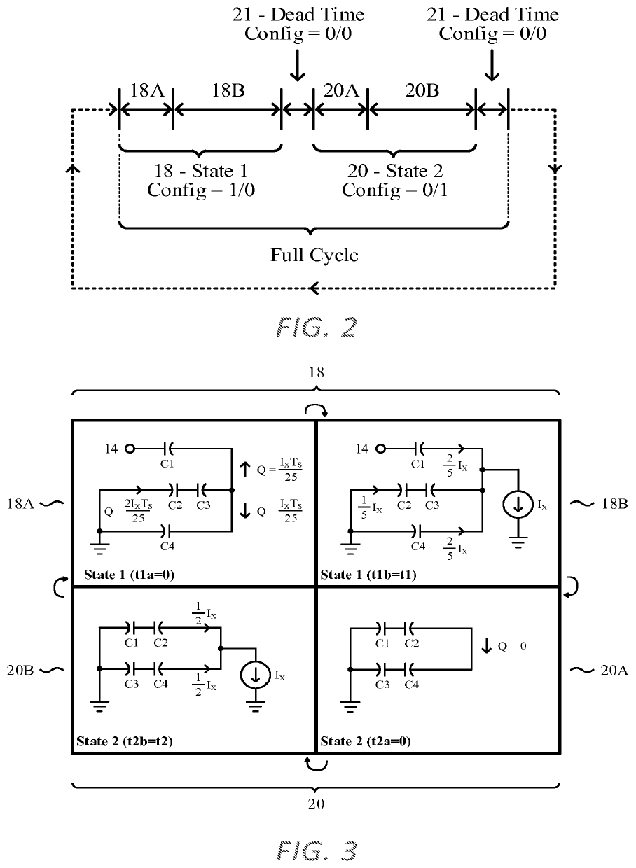

A first switch-set 1 and a second switch-set 2 cooperate to cause the charge pump 10 to reconfigure the pump capacitors C1-C4 between first and second pump-states 18, 20 as shown in FIG. 2. Through operation of the first and second switch-sets 1, 2, the charge pump 10 maintains a transformation ratio M:N between the voltages at the first and second terminals 14, 16. In the particular charge pump 10 shown in FIG. 1, the transformation ratio is 5:1.

In operation, the charge pump 10 executes a series of charge pump cycles. Each charge pump cycle has a first pump-state 18 and a second pump-state 20, as shown in FIG. 2. To transition from the first pump-state 18 to the second pump-state 20, the switches in the first switch-set 1 are opened and the switches in the second switch-set 2 are closed. Conversely, to transition from the second pump-state 20 into the first pump-state 18, the switches in the first switch-set 1 are closed and the switches in the second switch-set 2 are opened.

FIG. 2 shows the configuration of the switches as “Config X/Y” where X and Y are binary variables that indicate the disposition of the switches in the first and second switch-sets 1, 2 respectively. A binary zero indicates that the switches in a particular switch-set are open and a binary one indicates that the switches in a particular switch-set are closed.

During the first pump-state 18, the switches in the first switch-set 1 are all closed and the switches in the second switch-set 2 are all opened. The first pump-state 18 consists of a first pump-state redistribution interval 18A and a first pump-state steady-state interval 18B.

The first pump-state 18 begins with the opening of the switches in the second switch-set 2 and the closing of the switches in the first switch-set 1. This begins a first pump-state redistribution interval 18A characterized by a rapid redistribution of charge. For a brief period. the current associated with this charge distribution dwarfs that associated with the current through the load 12.

Eventually, the current associated with charge redistribution dies down and the charge pump 10 settles into a first pump-state steady-state interval 18B. During the first pump-state steady-state interval 18B, current through the charge pump 10 is dominated by the current through the load 12. The sum of the time spent in the first pump-state steady-state interval 18B and the first pump-state redistribution interval 18A is the first residence time.

During the second pump-state 20, the switches in the first switch-set 1 are all opened and the switches in the second switch-set 2 are all closed. The second pump-state 20 consists of a second pump-state redistribution interval 20A and a second pump-state steady-state interval 20B.

The second pump-state 20 begins with the closing of the switches in the second switch-set 2 and the opening of the switches in the first switch-set 1. This begins a second pump-state redistribution interval 20A characterized by a rapid redistribution of charge. For a brief period, the current associated with this charge distribution dwarfs that associated with the current through the load 12.

Eventually, the current associated with charge redistribution dies down and the charge pump 10 settles into a second pump-state steady-state interval 20B. During the second pump-state steady-state interval 20B, current through the charge pump 10 is once again dominated by the current through the load 12. The sum of the time spent in the second pump-state steady-state interval 20B and the second pump-state redistribution interval 20A is the second residence time.

In the course of transitioning between the first and second pump-states 18, 20 the voltage at the first phase-node P1 alternates between ground and the voltage at the second terminal 16. Meanwhile, the voltage at the second phase-node P2 is 180 degrees out-of-phase with the first phase-node P1.

Between the first pump-state 18 and the second pump-state 20 there is a dead-time interval 21 during which both the switches in the first switch-set 1 and the switches in the second switch-set 2 are open. Although not, in principle, required, this dead-time interval is a practical necessity because switches do not transition instantaneously. Thus, it is necessary to provide a margin to avoid the undesirable result of having switches in the first and second switch-sets 1, 2 closed at the same time.

To avoid having to introduce complexity that would only obscure understanding of the principles of operation, FIG. 3 shows currents passing through the pump capacitors C1-C4 in both the first and second pump-states 18, 20 assuming instantaneous charge-redistribution, no dead-time, and the same non-zero current, Ix, at the second terminal 16 in both pump-states.

In FIG. 3, the time spent in the first pump-state redistribution interval 18A is t1a; the time spent in the first pump-state steady-state interval 18B is t1b; the time spent in the second pump-state redistribution interval 20A is t2a; and the time spent in the second pump-state steady-state interval 20B is t2b. Lastly, the total length of one cycle is tsw. The first residence time is therefore t1a+t1b; and the second residence time is t2a+t2b. The assumption of instantaneous charge redistribution is manifested by setting t1a and t2a to zero, resulting in tsw being equal to t1b+t2b.

During the first pump-state steady-state interval 18B, the outer pump capacitors C1, C4 carry a current having a magnitude of 0.4 Ix while the inner pump capacitors C2, C3 carry a current having half of the magnitude carried by the outer pump capacitors C1, C4. This is because the inner pump capacitors C2, C3 are in series and the outer pump capacitors C1, C4 are by themselves.

During the second pump-state steady-state interval 20B, each outer pump capacitor C1, C4 is placed in series with one of the inner pump capacitors C2, C3, respectively. As a result, each pump capacitor C1-C4 carries a current with magnitude 0.5Ix. Note that the inner pump capacitors C2, C3 are always in series with another pump capacitor, whereas the outer pump capacitors C1, C4 are only in series with another pump capacitor during one pump-state.

In the limiting case where charge is redistributed instantly, the current sources can be removed during the first and second pump-state redistribution intervals 18A, 20A as in FIG. 3. The amount of charge that is redistributed depends upon the voltages across the pump capacitors C1-C4 prior to a pump-state change.

In general, it is desirable that the net charge change at any pump capacitor C1-C4 be zero during the course of a particular cycle. Otherwise, increasing/decreasing amounts of charge will collect in the pump capacitors C1-C4 over several cycles. This charge accretion/depletion over multiple cycles causes instability.

Since the quantity of charge transferred is the product of current and the amount of time the current flows, it follows that one can control the quantity of charge transferred to a pump capacitor C1-C4 in any portion of the cycle by controlling the amount of time that the charge pump 10 spends in that portion of the cycle. This provides a way to ensure that the net charge change at each pump capacitor C1-C4 is zero during one cycle of the charge pump 10.

If the above constraint is applied to each distinct capacitor current in a charge pump 10, it is possible to generate a system of linear equations in which the times spent in each pump-state are the unknowns. The solution to that system will be the residence times for each pump-state 18. 20 that avoid instability.

To avoid instability in this example, assuming instantaneous charge redistribution, the first residence time should be 3/5 tsw and the second residence time should be 2/5·tsw. This results in an equal amount of charge being transferred from inner pump capacitors C2, C3 to the first pump capacitor C1 and to the fourth pump capacitor C4 during the first pump-state redistribution interval 18A; and zero redistribution charge during the second pump-state redistribution interval 20A.

Solutions for various transformation ratios M:N are shown below in tabular form:

| | First residence | Second residence |
|---|---|---|
| M:N | time (sec) | Time (sec) |
| 3:1 | ⅔ · tsw | ⅓ · tsw |
| 4:1 | ½ · tsw | ½ · tsw |
| 5:1 | ⅗ · tsw | ⅖ · tsw |
| 6:1 | ½ · tsw | ½ · tsw |
| 7:1 | 4/7 · tsw | 3/7 · tsw |
| 8:1 | ½ · tsw | ½ · tsw |
| 9:1 | 5/9 · tsw | 4/9 · tsw |

Although there is no guarantee that every topology will have a solution, in the case of charge pumps like that in FIG. 1, a solution exists. As a result of symmetry in current flow during the first and second pump-state redistribution intervals 18A, 20A, the solution for cases in which the transformation ratio is 2k:1 for a positive integer k, the first and second residence times will be equal. Additionally, when M is odd and N is 1, the first residence time is tsw·(M+1)/2M while the second residence time is tsw·(M−1)/2M.

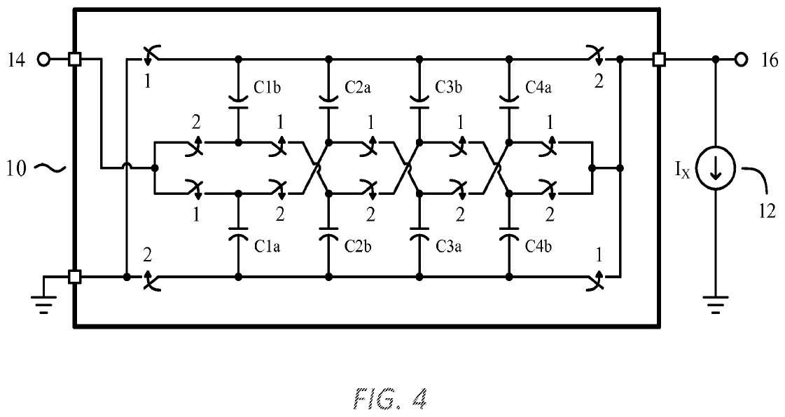

In the case of a two-phase charge pump 10, such as that shown in FIG. 4, the currents in the first and second pump-state redistribution intervals 18A, 20A are inherently symmetric, as shown in FIG. 5. Hence, the first and second pump-state residence times are equal, unlike in the single-phase charge pump 10 shown in FIG. 1, even though both charge pumps have the same transformation ratio M:N.

In general, the first and second pump-state residence times, in the case of charge pumps like that in FIG. 4, will be equal for any transformation ratio k:1, where k is a positive integer. This inherent symmetry provides two-phase charge pumps with an advantage over single-phase charge pumps when it comes to stability.

However, analysis based on principles of linear circuit theory is based on an idealization of the circuit. In practice, for example, due to differences in the capacitances of the various pump capacitors C1-C4 of FIG. 1, difference in circuit resistances, (e.g., through transistor switches and/or signal traces), or inexact timing of the pump-state durations, it can be difficult to manage charge accretion/depletion in the pump capacitors C1-C4.

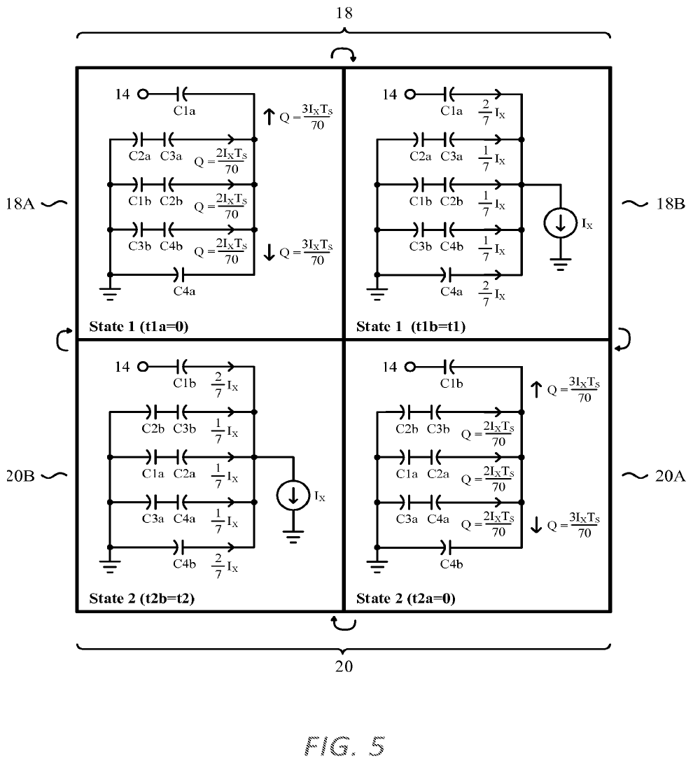

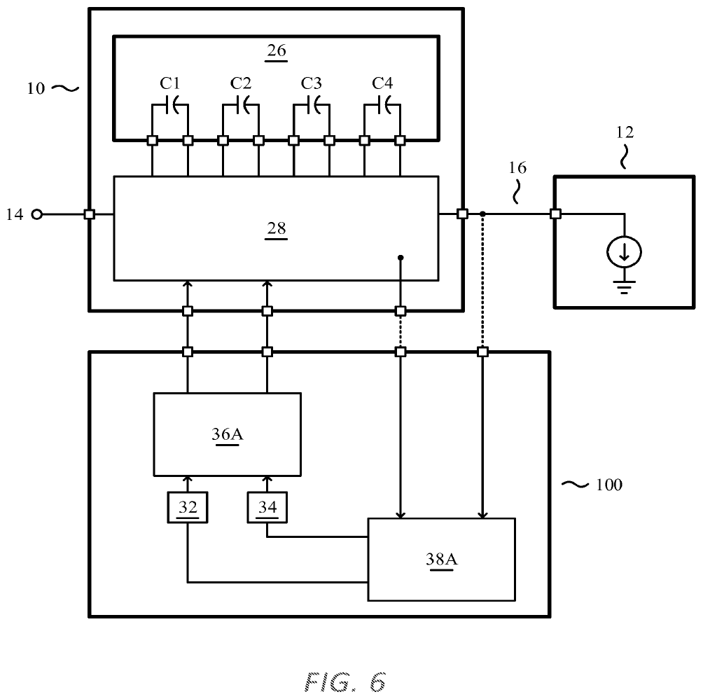

One method for managing charge accretion/depletion is to use feedback to control the residence times. FIG. 6 shows an apparatus to carry out such control.

For convenience in discussion, FIG. 6 shows the charge pump 10 as divided into a capacitor array 26 and a switch circuit 28. The capacitor array 26 includes the pump capacitors C1-C4 and the switch circuit 28 includes the first and second switch-sets 1, 2.

A first controller 100 identifies suitable residence times for each pump-state and stores those in first and second residence-time buffers 32, 34. At appropriate times, a first timing circuit 36A, which includes a clock to keep time, reads the residence-time buffers 32, 34 and causes the switches in the switch circuit 28 to transition at appropriate times.

To determine the correct values of the residence times, the first controller 100 includes a first feedback circuit 38A. In general, a feedback circuit will have a measured variable, and a manipulated variable that is to be manipulated in response to the measured variable in an effort to achieve some set point. For the first feedback circuit 38A, the manipulated variable is the pair of residence times, and the measured variable includes a voltage measured at the second terminal 16. Optionally, the measured variable for the first feedback circuit 38A includes measurements obtained from within the charge pump 10, hence the dotted lines within FIG. 6. Examples of such measurements include voltages across the switches in the first and second switch-sets 1, 2 or across pump capacitors C1-C4.

In one embodiment, the first feedback circuit 38A determines residence time values based on measurements taken over a sequence of cycles. The manipulated variable of the first controller 100 is chosen based on historical values. A suitable first controller 100 is a PID (proportional-integral-derivative) controller.

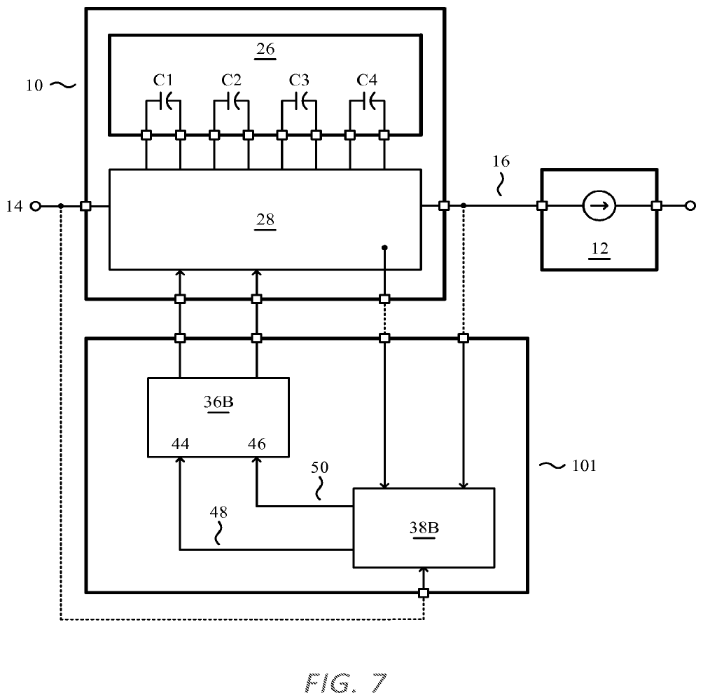

An advantage of the first controller 100 shown in FIG. 6 is that the frequency of the charge pump 10 is fixed. Another embodiment, shown in FIG. 7, features a second controller 101 that is configured to determine residence time values based on measurements obtained during the current cycle only. This allows residence time values to be determined on a cycle-by-cycle basis. As a result, the cycle length of the charge pump 10 can vary when using the second controller 101.

The second controller 101 includes a second timing circuit 36B that is similar to first timing circuit 36A described in FIG. 6. However, the second feedback circuit 38B is implemented as a threshold logic circuit that relies on comparing voltages.

A second timing circuit 36B provides state control signals to the switch circuit 28. During normal operation, the second timing circuit 36B causes transitions between the first and second pump-states 18, 20 using nominal first and second residence times. The nominal residence times can be based on circuit analysis assuming ideal circuit elements.

The second timing circuit 36B also includes first and second skew inputs 44, 46 to receive corresponding first and second skew signals 48, 50 from the second feedback circuit 38B. The second feedback circuit 38B asserts one of the first and second skew signals 48, 50 to prematurely force the charge pump 10 to change pump-states. The second feedback circuit 38B makes the decision to assert one of the first and second skew signals 48, 50 based on feedback from one or more sources. This feedback includes measurements of electrical parameters made at one or more of: the first terminal 14, the second terminal 16, inside the switch circuit 28, and inside the capacitor array 26.

If the second feedback circuit 38B does not assert either skew signal 48, 50, then the second timing circuit 36B causes the charge pump 10 to transition between its first and second pump-states 18, 20 according to the nominal first and second residence times. If, while the charge pump 10 is in the first pump-state 18, the second feedback circuit 38B presents an asserted first skew signal 48 to the first skew input 44, the second timing circuit 36B immediately causes the charge pump 10 to transition from the first pump-state 18 to the second pump-state 20. Conversely, if the second feedback circuit 38B presents an asserted second skew signal 50 to the second skew input 46 while the charge pump 10 is in the second pump-state 20. the second timing circuit 36B immediately causes the charge pump 10 to transition from the second pump-state 20 to the first pump-state 18.

An advantage of the second controller 101 is that it reacts immediately on a cycle-by-cycle basis. This means that the capacitors inside the capacitor array 26 can be stabilized faster. In fact, since the second controller 101 operates by prematurely terminating charge pump-states 18, 20, the notion of a frequency is not well defined.

Note that shortening the first residence time while keeping the second residence time constant will generally result in an upward drift and/or a reduction in the amplitude of a lower excursion of output voltage ripple. Therefore, in one example, when the second feedback circuit 38B detects either a downward drift in the average output or an excessive lower excursion of the output ripple, it presents an asserted first skew signal 48 to the first skew input 44, thus truncating the first pump-state 18 and shortening the first residence time.

Conversely, in another example, upon detecting an upward drift and/or an excessive upward excursion of the ripple, the second feedback circuit 38B presents an asserted second skew signal 50 to the second skew input 46, thereby truncating the second pump-state 20 and shortening the second residence time.

As noted above, the second feedback circuit 38B receives measurements of electrical parameters from one or more locations. However, these measurements would be meaningless without some way for the second feedback circuit 38B to know whether the measured values are normal or not. To remedy this, it is desirable to provide expected values of these electrical parameters.

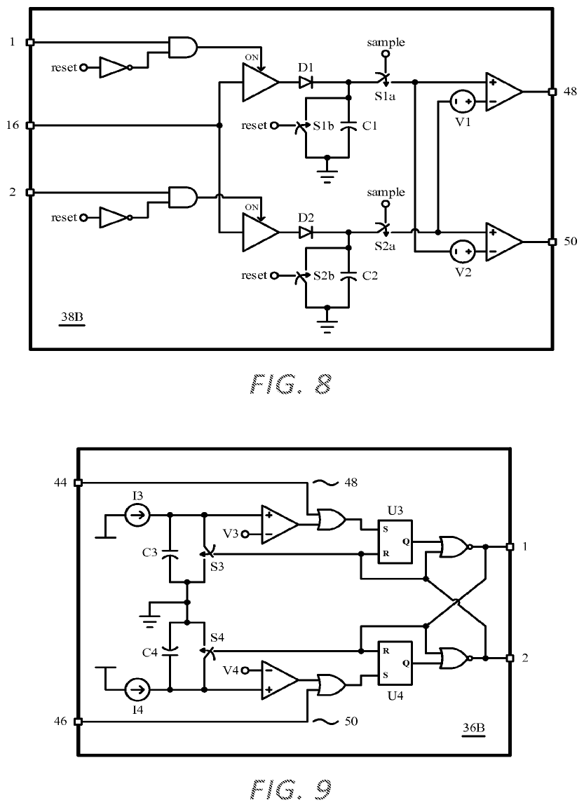

The thresholds provided to the second feedback circuit 38B can be derived in many ways. One way is through analysis of an ideal circuit corresponding to the charge pump 10. Another way is through simulation of a physical charge pump 10. Either of these techniques can be used to provide expected values for an average output voltage (e.g., as a multiple of the input voltage) and expected maximum and minimum values of output voltage ripple about that average. The second feedback circuit 38B uses such pre-computed values in setting the thresholds at which the skew signals 48, 50 are asserted. Similar logic can be used to implement the first feedback circuit 38A discussed in connection with FIG. 6. FIG. 8 shows an implementation of the second feedback circuit 38B shown in FIG. 7 that limits the peaks not valleys. The illustrated feedback circuit 38B uses first and second peak-detectors to sense the peak voltage at the second terminal 16 during the first and second pump-states 18, 20 respectively. The first peak-detector comprises a first voltage-buffer and a first diode D1. The second peak-detector comprises a second voltage-buffer and a second diode D2. The first peak-detector stores the peak voltage during the first pump-state 18 in a first peak-storage capacitor C1. The second peak-detector stores the peak voltage during the second pump-state 20 in a second peak-storage capacitor C2.

The stored peak voltages on the first and second peak-storage capacitors C1, C2 can then be connected to the inputs of corresponding first and second peak-voltage comparators by closing first and second switches S1a, S2a simultaneously. This compares the peak voltages that were stored on the first and second peak-storage capacitors C1, C2 during the preceding first and second pump-states 18, 20.

If the peak voltage during the first pump-state 18 exceeded that of the second pump-state 20 by a first threshold V1, then the first peak-voltage comparator asserts the first skew signal 48. Conversely if the peak voltage during the second pump-state 20 exceeded that of the first pump-state 18 by a second threshold V2, then the second peak-voltage comparator asserts the second skew signal 50.

The first and second skew signals 48, 50 from the second feedback circuit 38B make their way to the second timing circuit 36B, an implementation of which is shown in FIG. 9. The second timing circuit 36B uses these first and second skew signals 48, 50 to generate non-overlapping signals that control the first and second switch-sets 1, 2. In the illustrated embodiment, there is no gap between the two pump-states 18, 20. The first pump-state 18 starts upon a transition from the second pump-state 20, and vice-versa.

In operation, the circuit shown in FIG. 9 begins the first pump-state 18 by closing a first switch S4. This resets a first timing-capacitor C4 to be low. Meanwhile, a first SR latch U4 is in the reset state. During the first pump-state 18, an open second switch S3 allows a first bias-current 13 to charge a second timing-capacitor C3. Eventually, the first bias-current I3 will have deposited enough charge in the second timing-capacitor C3 to raise its voltage beyond a first voltage-threshold V3 at the input of a first voltage comparator. When this happens, the first voltage comparator outputs a logical high. This, in tum, sets a second SR latch U3, thus terminating the first pump-state 18. Thus, in the absence of an asserted first skew signal 48, the residence time of the first pump-state 18 depends upon the first bias-current I3, the capacitance of the second timing-capacitor C3, and the first voltage-threshold V3.

Upon terminating the first pump-state 18, the second pump-state 20 begins. The operation during the second pump-state 20 is similar to that described above for the first pump-state 18.

At the start of the second pump-state 20, the first switch S4 opens, thus allowing a second bias-current I4 to charge the first timing-capacitor C4. Eventually, the second bias-current I4 will have deposited enough charge in the first timing-capacitor C4 to raise its voltage past a second voltage-threshold V4 at the input of a second voltage comparator. In response to this, the second voltage comparator outputs a logical high that sets the first SR latch U4, thus terminating the second pump-state 20. During the second pump-state 20, the second timing-capacitor C3 is reset low when the second switch S3 is closed, and the second SR latch U3 is in the reset state. In the absence of an asserted second skew signal 50, the residence time of the second pump-state 20 is set by the second bias-current I4, the capacitance of the first timing-capacitor C4, and the second voltage-threshold V4.

The first skew signal 48 and the output of the first voltage comparator are inputs to a first OR-gate. Thus, the first pump-state 18 can be terminated in two ways. In the first way, already described above, the first pump-state 18 lasts for its nominal residence time and terminates once enough charge has accumulated in the second timing-capacitor C3. However, while the second timing-capacitor C3 is still being filled with charge, the second feedback circuit 38B may assert the first skew signal 48, thus bringing the first pump-state 18 to a premature end.

It will be apparent from the symmetry of the circuit shown in FIG. 9 that the second pump-state 20 can be truncated in the same way by assertion of the second skew signal 50. The second feedback circuit 38B is thus able to shorten the first residence time relative to the second by asserting the first skew signal 48 but not the second skew signal 50.

After each comparison of the peak voltage in the first and second pump-states 18, 20, the first and second peak-storage capacitors C1, C2 of the second feedback circuit 38B are reset by closing third and fourth switches S1b, S2b and opening the first and second switches S1a, S2a. Also, the voltage buffers that sense the voltage at the second terminal 16 can be disabled or tri-stated while the first and second peak-storage capacitors C1, C2 are reset. Each sample-compare-reset cycle can occur once per charge pump cycle or once per set of multiple consecutive charge pump cycles.

In the methods described above, there have been only two pump-states 18, 20 and two residence times. However, the principles described are not limited to merely two pump-states 18, 20. For example, it is possible to implement a dead time interval during which the charge pump 10 is not doing anything. This dead time interval can be used in connection with the embodiment described in FIG. 7 to cause fixed frequency operation. To do so, the dead time interval is set to be the difference between a nominal charge pump period and the sum of the first and second pump-state intervals.

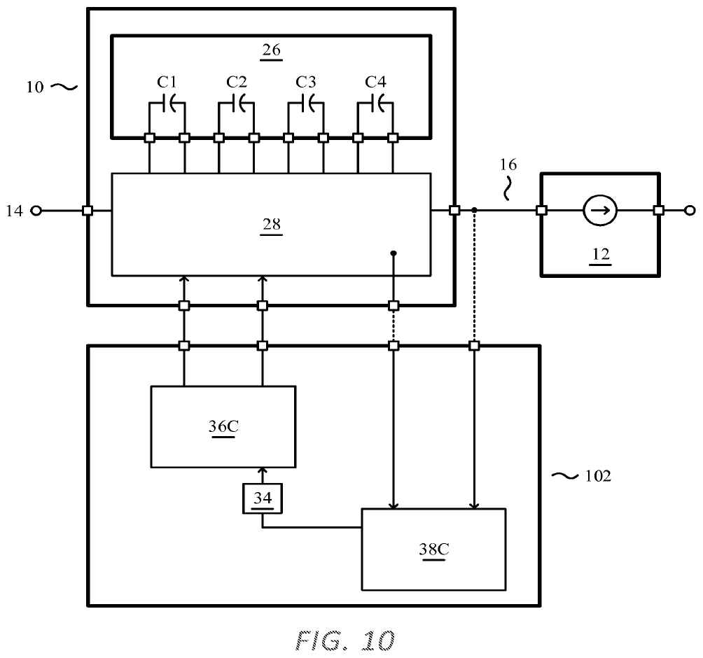

FIG. 10 shows one implementation for carrying out a three-state charge pump that defines a dead time as its third state. The embodiment shown in FIG. 10, features a third controller 102 that uses a third feedback circuit 38C connected to a third timing circuit 36C to exercise control over only a second residence time in the second residence-time buffer 34, and not the first residence time. In this embodiment, the first residence time is always set to some nominal value. The third controller 102 features an input from the switch circuit 28 that provides information on the state of the first switch-set 1. Based on this information, if the third controller 102 determines that the switches in the first switch-set 1 are open, it has two choices. The first choice is to close the switches in the second switch-set 2. This initiates the second residence time. The second choice is to leave the switches in the second switch-set 2 open. This initiates a dead-time interval. For proper operation, the first and second residence times must be non-zero.

The dead-time interval is an example of a third pump-state in which no charge transfer occurs. However, it is also possible to operate a charge pump in three or more states, each one of which permits charge transfer between capacitors. An example of such multi-state charge pump control is given in U.S. Provisional Application 61/953,270, in particular, beginning on page 11 thereof, the contents of which are herein incorporated by reference.

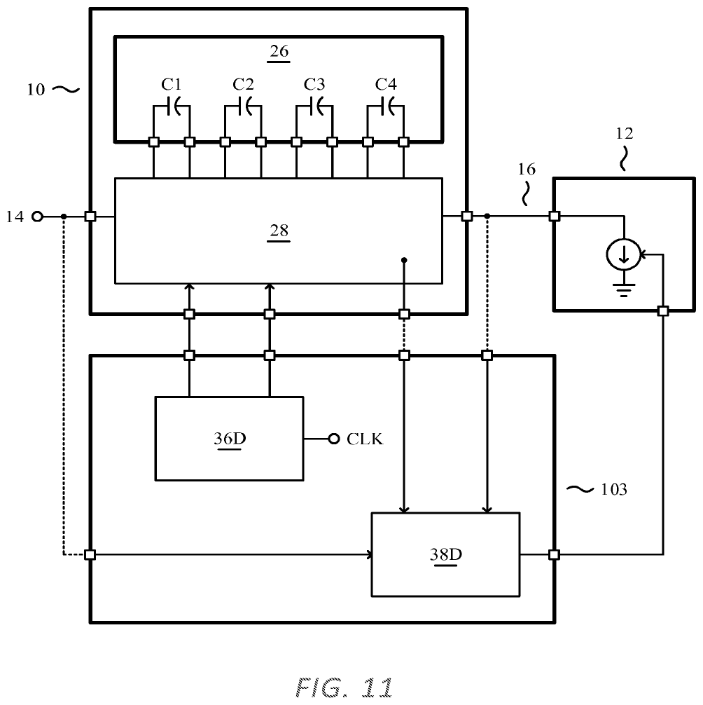

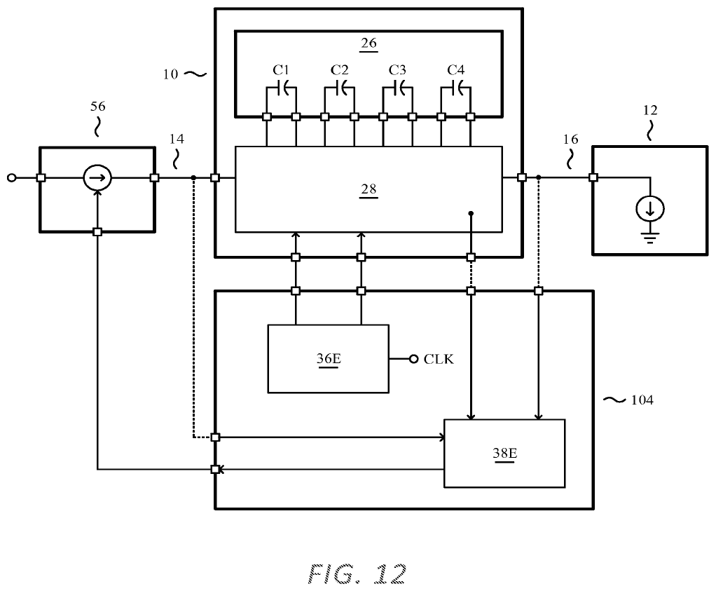

The rate at which charge accumulates on a capacitor depends on the current and the amount of time the current is allowed to flow. The methods disclosed thus far manage charge accumulation by controlling the second of these two parameters: the amount of time current is allowed to flow. However, it is also possible to control the first of these two parameters, namely the amount of current that flows. Embodiments that carry out this procedure are shown in FIGS. 11 and 12.

FIG. 11 shows a fourth controller 103 similar to the second controller 101 shown in FIG. 7 but with no connection between a fourth feedback circuit 38D and a fourth timing circuit 36D. Thus, unlike the second controller 101, the fourth controller 103 does not vary the first and second residence times. Instead, the fourth feedback circuit 38D of the fourth controller 103 adjusts the current drawn by the load 12, such as an IDAC within a LED driver, while allowing the first and second residence intervals to be derived from a constant clock signal CLK. The fourth feedback circuit 38D makes the decision on an extent to which to vary the current drawn by the load 12 based on feedback measurements from one or more sources. These include measurements of electrical parameters made at one or more of the first terminal 14, the second terminal 16, inside the switch circuit 28, and inside the capacitor array 26.

FIG. 12 shows a fifth controller 104 that is similar to the fourth controller 103 except that instead of controlling current drawn by a load 12, the fifth controller 104 controls current through a regulator 56, which is modeled in the illustrated circuit as a current source. In the fifth controller 104, a fifth timing circuit 36E responds only to a clock signal CLK. A fifth feedback circuit 38E decides how much to vary the current through the regulator 56 based on feedback measurements from one or more sources. These include measurements of electrical parameters made at one or more of the first terminal 14, the second terminal 16, inside the switch circuit 28, and inside the capacitor array 26.

The control methods described above are not mutually exclusive. As such, it is possible to implement hybrid controllers that implement two or more of the control methods described above.

One reason that charge accretion/depletion becomes a problem is that, as a practical matter, it is next to impossible to manufacture pump capacitors C1-C4 that all have the same desired capacitance. Referring now to FIG. 13, a remedy for this is to compensate for an error in the value of a pump capacitor's capacitance by switching other capacitors in series or in parallel with that pump capacitor. These capacitors are referred to as “trim” capacitors because they trim a capacitance to a desired value. The term “trim” is not be construed as “reducing” but rather in the sense of making fine adjustments in any direction in an effort to attain a desired value. Capacitance of a pump capacitor can be raised or lowered by connecting another capacitor in parallel or in series respectively.

FIG. 13 shows a trim-capacitor network 70 having two trim capacitors C5, C6, either one of which can be placed in parallel with the fourth pump capacitor C4. Although only two trim capacitors C5, C6 are shown, a practical trim-capacitor network 70 has an assortment of capacitors with various values that can be selectively switched in series or in parallel with the fourth pump capacitor C4. The illustrated trim-capacitor network 70 is shown connecting one trim capacitor C6 in parallel with the pump capacitor C4, thus raising the effective capacitance of the combination. Only two trim capacitors C5, C6 are shown for clarity. However, it is a simple matter to add more, thus allowing greater variability in adjustment. In addition, for the sake of simplicity, the trim-capacitor network 70 shown only places trim capacitors C5, C6 in parallel. However, it is a relatively simple matter to design a circuit to switch trim capacitors C5, C6 in series with the fourth pump capacitor C4. Additionally, in FIG. 13, a trim-capacitor network 70 is shown only for the fourth pump capacitor C4. In practice, each pump capacitor C1-C4 would have its own trim-capacitor network 70.

By switching in the proper combination of trim capacitors in the trim-capacitor network 70, the overall capacitance of the pump capacitor C4 combined with that of the trim capacitors C5, C6 can be made to approach or even equal a target value. This trimming procedure may only need to be carried out once in the lifetime of the charge pump 10 or can be carried out during normal operation because the capacitance of practical capacitors normally vary with the voltage across their terminals as well as temperature.

Rather than being used once to adjust for manufacturing errors, a trim-capacitor network 70 as shown can also be used during operation of the circuit as a way to control the quantity of charge on a particular pump capacitor C4 by transferring charge between a particular capacitor, e.g. the pump capacitor C4, and some other charge repository, such as a trim capacitor C5, C6 within the trim-capacitor network 70, or to the ultimate repository, which is ground. This provides an alternative way to adjust the charge on each capacitor in an effort to restore all pump capacitors to their respective initial voltages at the start of a charge pump cycle.

Alternately, a current sink could be coupled to each pump capacitor C1-C4 allowing it to bleed any excess charge to another location or multiple locations, such as the first terminal 14. the second terminal 16, a terminal inside the switch circuit 28, a terminal inside the capacitor array 26, and even ground.

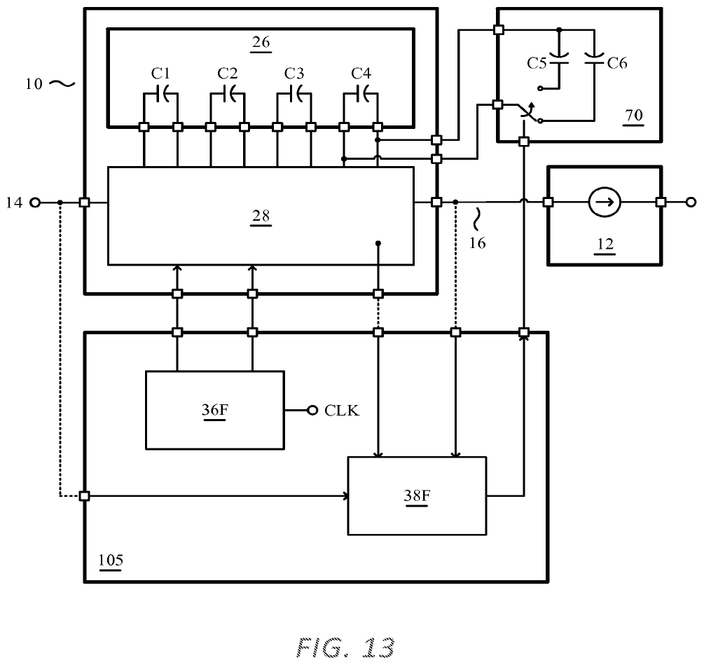

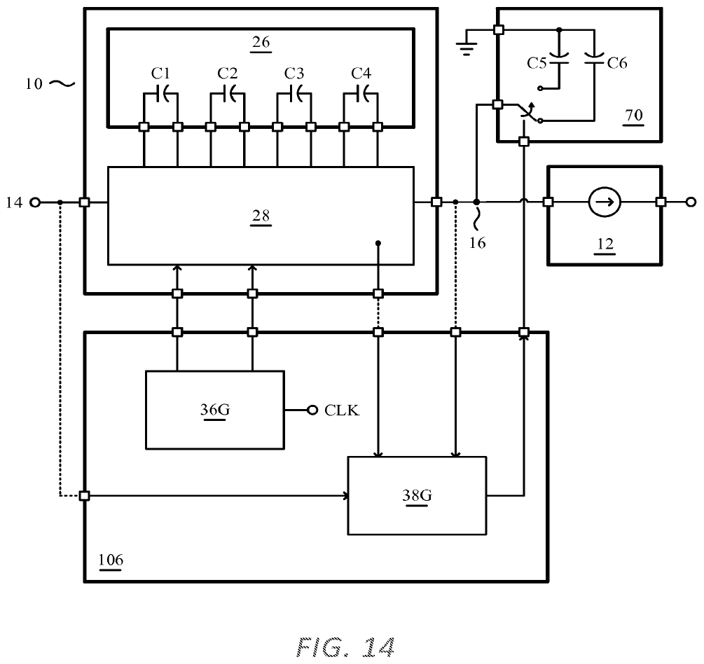

Another use for the trim-capacitor network 70, shown in FIG. 14, is to act as a stabilizing capacitance between the charge pump 10 and the load 12. To reduce losses, the stabilizing capacitance is preferably just sufficient to stabilize the charge pump 10. A larger stabilizing capacitance value than necessary may increase power loss during charge pump operation. Because of manufacturing tolerances, it will, in general, not be possible to either predict the required value of the stabilizing capacitance or, even if a prediction were available, to ensure that it has the required value over all operating conditions. Thus, one can use a technique similar to that described in connection with FIG. 13 to switch a selected trim capacitor C5, C6 from the trim-capacitor network to act as a stabilizing capacitance.

The charge pump 10 can be implemented using many different charge pump topologies such as Ladder, Dickson, Series-Parallel, Fibonacci, and Doubler. Similarly, suitable converters for the regulator 56 and for the load 12 when implemented as a regulator include: Buck converters, Boost converters, Buck-Boost converters, non-inverting Buck-Boost converters, Cuk converters, SEPIC converters, resonant converters, multi-level converters, Flyback converters, Forward converters, and Full Bridge converters.

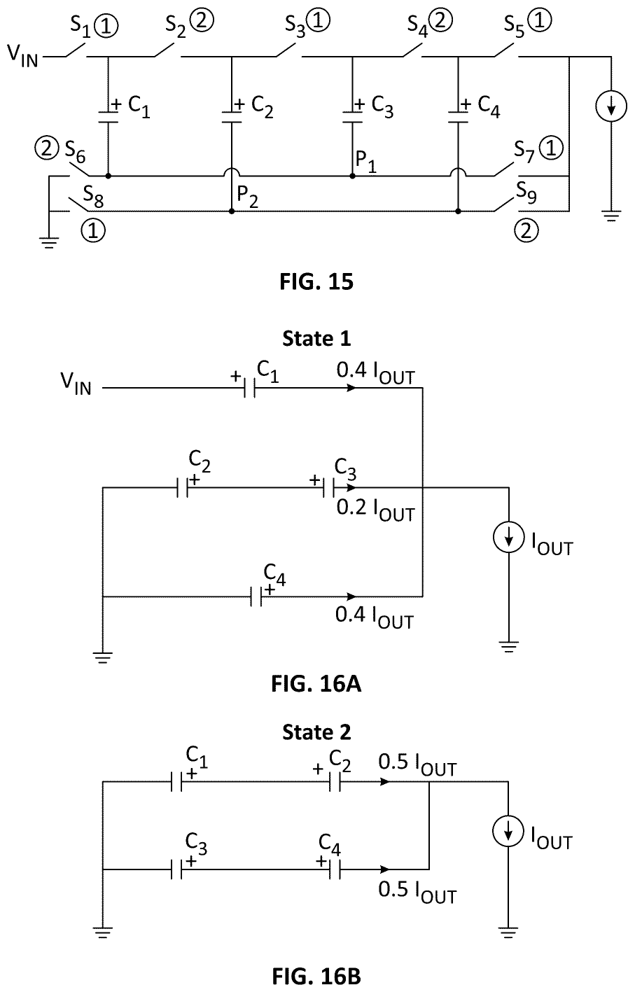

In accordance with further embodiments as set forth in FIGS. 15 through 25, a first example charge pump is shown in FIG. 15 to illustrate a source of charge imbalance in the operation of such a charge pump. The charge pump is configured to nominally provide a 5:1 (i.e., M=5) step-down in voltage such that V_{OUT} (volts) is one-fifth of the input voltage V_{IN} (volts). Four capacitors (labeled C₁ to C₄) are used with switches (labeled S₁ to S₉) on both terminals of each capacitor to store a fraction of V_{IN} and transfer charge from one capacitor to the next. The capacitors closest to the V_{IN} and V_{OUT} terminals are labeled C₁ and C₄, respectively, and are referred to below as the “outer” capacitors, while the remaining capacitors labeled C₂ and C₃ are referred to below as the “inner” capacitors. As further notation, the voltage and charge on a capacitor Cₖ are denoted V_{R} and Qₖ, respectively. Unless otherwise indicated, the capacitors are treated as ideally having identical capacitance C (Farads).

The charge pump is operated by controlling a set of switches (S₁ through S₉) that cause charge to pass between the capacitors and between the terminals and the capacitors. The control of the switches of the charge pump can be represented as a cycle through a series of states, where each state is associated with a particular configuration of the set of switches (i.e., a particular setting of open-circuit (non-conducting) and closed-circuit (conducting) configuration of each of the switches).

One mode of operation of the charge pump shown in FIG. 15 uses a cycle of two states. In a state 1, the switches labeled “1” (i.e., S₁, S₃, S₅, S₇, S₈) are closed and the switches labeled “2” (i.e., S₂, S₄, S₆, S₉) are open during state 1. In a state 2, the switches labeled “1” are open and the switches labeled “2” are closed. These configurations of switches are shown in tabular form (“1” indicating the switch is closed and “0” indicating that the switch is open) as follows:

| | Switch | | | | | | | | |
|---|---|---|---|---|---|---|---|---|---|
| State | S₁ | S₂ | S₃ | S₄ | S₅ | S₆ | S₇ | S₈ | S₉ |
| State 1 | 1 | 0 | 1 | 0 | 1 | 0 | 1 | 1 | 0 |
| State 2 | 0 | 1 | 0 | 1 | 0 | 1 | 0 | 0 | 1 |

Note that in practice, additional states may be needed in which all or a sufficient set of switches are open such that charge is not passing to or from the capacitors without affecting the overall function of the charge pump, for example, in a “break before make” approach to avoid the necessity of truly instantaneous switching. However, for the analysis of the ideal behavior below, such additional states are not generally considered.

A complete cycle of the charge pump has a sequence of two states, state 1 followed by state 2. A first phase node P₁ couples with the negative terminal of capacitors C₁ and C₃, and a second phase node P₂ couples with the negative terminal of capacitors C₂ and C₄. The voltage at the first phase node P₁ alternates between ground and the output voltage V_{OUT}, and the voltage at the second phase node P₂ is out of phase with the first phase node P₁.

In steady-state operation, capacitors C₁-C₄ have nominal voltages across their terminals that are multiples of the output voltage:

$${V}_{1}^{( nom )} = 4 * {V}_{OUT}^{( nom )} = ( 4 / 5 ) * {V}_{IN}$$

$${V}_{2}^{( nom )} = 3 * {V}_{OUT}^{( nom )} = ( 3 / 5 ) * {V}_{IN}$$

$${V}_{3}^{( nom )} = 2 * {V}_{OUT}^{( nom )} = ( 2 / 5 ) * {V}_{IN}$$

$${V}_{4}^{( nom )} = 1 * {V}_{OUT}^{( nom )} = ( 1 / 5 ) * {V}_{IN}$$

For example, with V_{IN} equal to 25.0 (volts), the nominal voltages across the capacitors C₁ to C₄ are 20.0, 15.0, 10.0, and 5.0 (volts), respectively, and the nominal output voltage is 5.0 (volts). The actual voltages across the capacitors vary around these nominal values (i.e., the voltage exhibits “ripple”) during a cycle of the successive states of operation of the charge pump, denoted as

$${V}_{k} = {V}_{k}^{( nom )} + {v}_{k}$$

In this example, the output terminal of the charge pump is treated as being coupled to a currentload, with current I_{OUT}. In some examples, this current is assumed constant, in a configuration referred to generally as “adiabatic” operation. More generally, as discussed further below, the current may be pulsed with a constant average Ī_{OUT}=D*I_{OUT}^{(peak)}, where D is the duty cycle (a fraction between zero and one) of the pulsed current source. In general, the frequency of the current source switching is a multiple times the frequency of the charge pump switching (e.g., 2×, 3×, 10×, 100×). In some examples, the current may be constant during each state, but have different values during each state. Furthermore, state transition instants are preferably chosen to occur during the zero-current part of the output current duty cycle, thereby reducing switching losses with non-ideal (e.g., transistor) switches. But for the sake of discussion of this first example, only the constant current case is considered.

Referring to FIGS. 16A and 16B, the equivalent circuits of the circuit in FIG. 15 are shown for state 1 and state 2, respectively. During state 1, the outer capacitors C₁ and C₄ carry a current magnitude of 0.4*I_{OUT} while the inner capacitors C₂ and C₃ each carry 0.2*I_{OUT} or half the magnitude of the outer capacitor current. Therefore, if state 1 has a duration t₁, then the change in charge on C₁ and C₄, denoted ΔQ_{j,k} as the change in charge on capacitor Cⱼ during state k, satisfy +ΔQ_{1,1}=−ΔQ_{4,1}=t₁*0.4*Ī_{OUT} while the change in charge on capacitors C₂ and C₃ during state 1 satisfy −ΔQ_{2,1}=−ΔQ_{3,1}=t₁*0.2*Ī_{OUT}. Note that the inner capacitors are connected in series while the outer capacitors are the only elements in their respective paths, causing the current to divide accordingly by the number of series capacitors.

During state 2, every capacitor carries a current magnitude of 0.5*Ī_{OUT} . The inner capacitors are always in a series connection with another capacitor in either state while the outer capacitors have a similar series connection only during state 2. The current flow polarity through each capacitor changes back and forth from one state to the next state as needed to charge and discharge the capacitor and maintain a constant average voltage across the capacitor.

If the charge pump were controlled at a 50% duty cycle with t₁=t₂=0.5*T_{SW}, where T_{SW} is the total duration of the switching cycle, the net charge across each cycle of two states on each capacitor Cₖ, ΔQₖ=ΔQ_{k,1}+ΔQ_{k,2}, is not zero. A consequence of this is that the net charge and average voltage on the capacitors may drift over successive cycles, and/or may cause a sizeable redistribution of charge at each state transition, neither of which may be desirable.

An alternative three-state control of the charge pump shown in FIG. 15 uses states labeled “1a”, “1b”, and “2”. The configuration of the switches in these states is shown in tabular form as follows:

| | Switch | | | | | | | | |
|---|---|---|---|---|---|---|---|---|---|
| e | S₁ | S₂ | S₃ | S₄ | S₅ | S₆ | S₇ | S₈ | S₉ |
| State 1a | 1 | 0 | 0 | 0 | 1 | 0 | 1 | 1 | 0 |
| State 1b | 0 | 0 | 1 | 0 | 0 | 0 | 1 | 1 | 0 |
| State 2 | 0 | 1 | 0 | 1 | 0 | 1 | 0 | 0 | 1 |

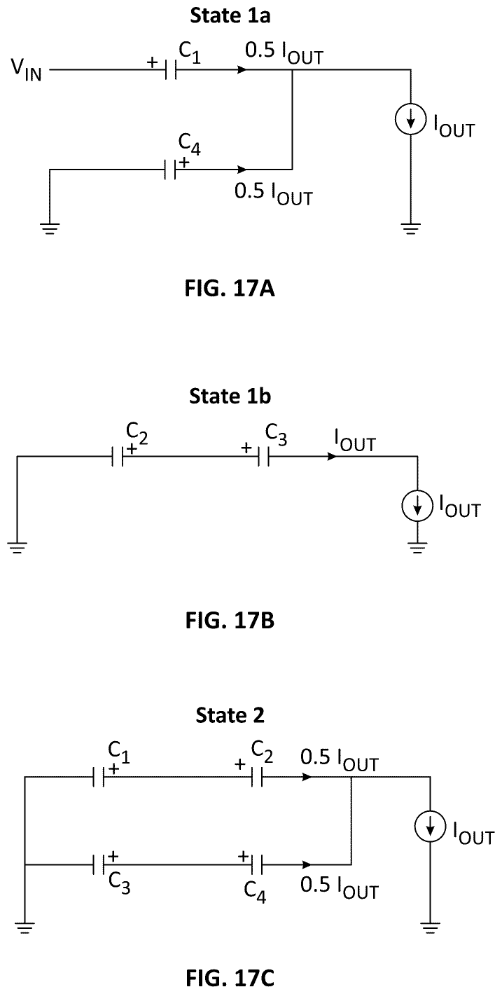

The equivalent circuits in each of these states are shown in FIGS. 17A-C, respectively. Note that in state 1a, a current of 0.5*I_{OUT} passes through each of capacitors C₁ and C₄ (with opposite voltage polarities), in state 1b, a current of 1.0*I_{OUT} passes through capacitors C₂ and C₃, and in state 2, a current of 0.5*I_{OUT} passes through all four capacitors. A suitable selection of state durations or times t₁ₐ, t_{1b}, and t₂ to balance the total change in charge in each cycle must satisfy the set of equations

$$Δ {Q}_{1} = 0 = + 0.5 {t}_{1 a} - 0.5 {t}_{2}$$

$$Δ {Q}_{2} = 0 = - 1. {t}_{1 b} + 0.5 {t}_{2}$$

$$Δ {Q}_{3} = 0 = + 1. {t}_{1 b} - 0.5 {t}_{2}$$

$$Δ {Q}_{4} = 0 = - 0.5 {t}_{1 a} + 0.5 {t}_{2}$$

$${T}_{SW} = + 1. {t}_{1 a} + 1. {t}_{1 b} + 1. {t}_{2}$$

The set of equations are satisfied with

$${t}_{1 a} = 0.4 * {T}_{SW}$$

$${t}_{1 b} = 0.2 * {T}_{SW}$$

$${t}_{2} = 0.4 * {T}_{SW}$$

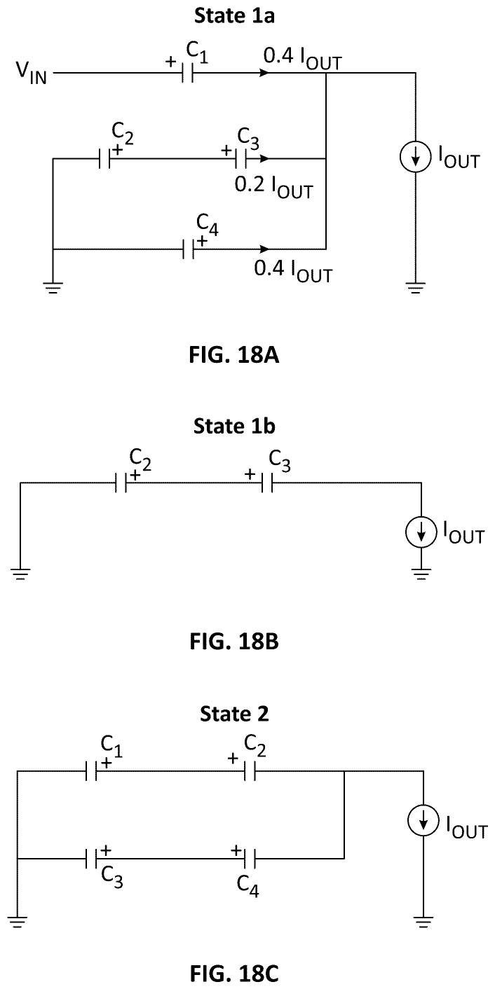

Another three-state approach to controlling the charge pump of FIG. 15 uses a different sequence of states with switch configurations and corresponding equivalent circuits shown in FIGS. 18A-C, respectively. The configuration of switches in the three states is shown in tabular form as:

| | Switch | | | | | | | | |
|---|---|---|---|---|---|---|---|---|---|
| State | S₁ | S₂ | S₃ | S₄ | S₅ | S₆ | S₇ | S₈ | S₉ |
| State 1a | 1 | 0 | 1 | 0 | 1 | 0 | 1 | 1 | 0 |
| State 1b | 0 | 0 | 1 | 0 | 0 | 0 | 1 | 1 | 0 |
| State 2 | 0 | 1 | 0 | 1 | 0 | 1 | 0 | 0 | 1 |

An analysis as presented above applied to this definition of the states yields state times that satisfy the charge balance equations of

$${t}_{1 a} = 0.5 * {T}_{SW}$$

$${t}_{1 b} = 0.1 * {T}_{SW}$$

$${t}_{2} = 0.4 * {T}_{SW}$$

A consideration of the sum of the RMS (root mean squared) currents through the capacitors shows that these state definitions yield a lower value than that of the previously described three-state configuration (FIGS. 17A-C). In a non-ideal implementation of the charge pump, in which resistances including resistances in series with the capacitors cause power loss, a lower RMS current is associated with smaller power loss. Therefore, these state configurations may be preferable.

Note that different sequences of states can still result in charge balance over the repeating cycle. For example, the state sequence 1a-1b-2-1 a-1b-2 . . . can be replaced with the sequence 1b-1a-2-1b-1a-2 . . . using the same state durations as determined above.

Other state definitions and timing also follow the approach outlined above. For instance, two additional approaches for the M=5 case as shown below in tabular form:

| | Switch | | | | | | | | | |
|---|---|---|---|---|---|---|---|---|---|---|
| State | S₁ | S₂ | S₃ | S₄ | S₅ | S₆ | S₇ | S₈ | S₉ | Time |
| State 1a | 0 | 0 | 1 | 0 | 1 | 0 | 1 | 1 | 0 | 0.3*T_{SW} |
| State 1b | 1 | 0 | 1 | 0 | 0 | 0 | 1 | 1 | 0 | 0.3*T_{SW} |
| State 2 | 0 | 1 | 0 | 1 | 0 | 1 | 0 | 0 | 1 | 0.4*T_{SW} |

and

| | Switch | | | | | | | | | |
|---|---|---|---|---|---|---|---|---|---|---|
| State | S₁ | S₂ | S₃ | S₄ | S₅ | S₆ | S₇ | S₈ | S₉ | Time |
| State 1a | 1 | 0 | 0 | 0 | 0 | 0 | 1 | X | 0 | 0.2*T_{SW} |
| State 1b | 0 | 0 | 0 | 0 | 1 | 0 | X | 1 | 0 | 0.2*T_{SW} |
| State 1c | 0 | 0 | 1 | 0 | 0 | 0 | 1 | 1 | 1 | 0.2*T_{SW} |
| State 2 | 0 | 1 | 0 | 1 | 0 | 1 | 0 | 0 | 1 | 0.4*T_{SW} |

where X indicates that the switch can either be open or closed.

The three-state approach presented above for the M=5 circuit of FIG. 15 may be extended directly to other odd values of M as shown in FIGS. 18A-18C. Generally, in state 1a, capacitor C₁ is in parallel with capacitor CM₋₁, and when M≥5 in parallel with series connections of C₂ and C₃, through C_{M-3} and C_{M-2}. State 1b has the parallel connection of the series of C₂ and C₃, through C_{M-3} and C_{M-2}, and state 2 has the parallel connection of the series C₁ and C₂ through C_{M-2} and C_{M-1}. A closed form of the state times for general odd M can then be expressed as

$${t}_{1 a} = ( M + 5 ) / ( 4 M ) * {T}_{SW}$$

$${t}_{1 b} = ( M - 3 ) / ( 4 M ) * {T}_{SW}$$

$${t}_{2} = ( M - 1 ) / ( 2 M ) * {T}_{SW}$$

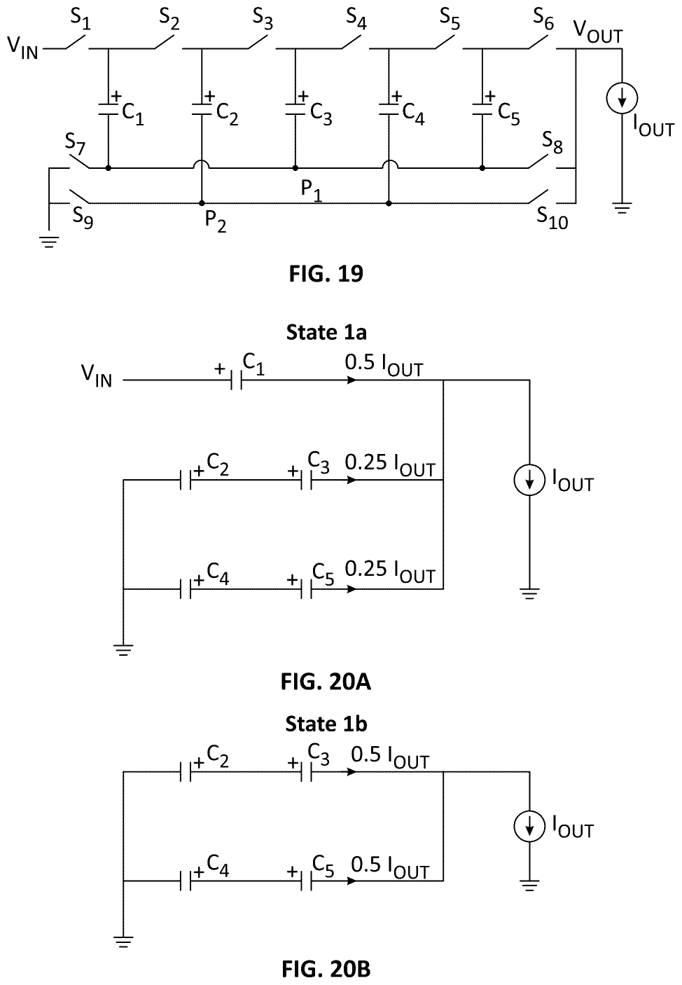

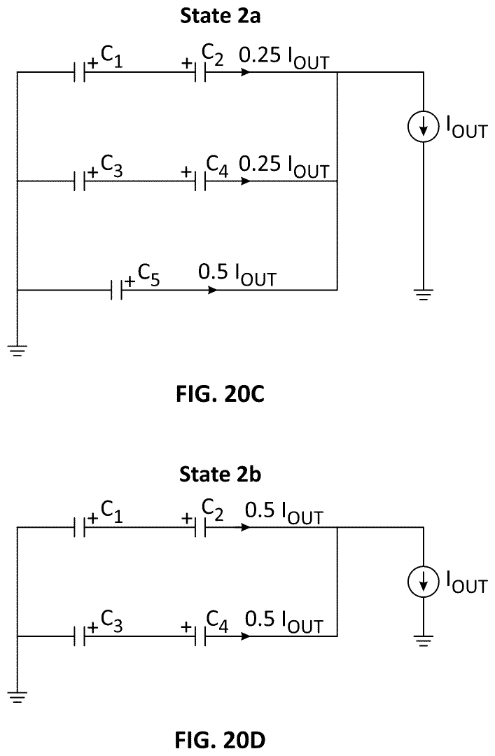

A similar approach can be applied to situations where M is even. Referring to FIG. 19, a 6:1 (M=6) charge pump is shown that includes ten switches labeled S₁ to S₁₀ and five capacitors C₁ to C₅. The configurations for the switches in each of four states: 1a, 1b, 2a, and 2b, are shown in the table below. The equivalent circuits in each of these states are shown in FIGS. 20A-D, respectively.

| | Switch | | | | | | | | | |
|---|---|---|---|---|---|---|---|---|---|---|
| State | S₁ | S₂ | S₃ | S₄ | S₅ | S₆ | S₇ | S₈ | S₉ | S₁₀ |
| State 1a | 1 | 0 | 1 | 0 | 1 | 0 | 0 | 1 | 1 | 0 |
| State 1b | 0 | 0 | 1 | 0 | 1 | 0 | 0 | 1 | 1 | 0 |
| State 2a | 0 | 1 | 0 | 1 | 0 | 1 | 1 | 0 | 0 | 1 |
| State 2b | 0 | 1 | 0 | 1 | 0 | 0 | 1 | 0 | 0 | 1 |

Applying the type of analysis described above, the state times to achieve a balancing of charge transfer through the cycle of states yields:

$${t}_{1 a} = 1 / 3 * {T}_{SW}$$

$${t}_{1 b} = 1 / 6 * {T}_{SW}$$

$${t}_{2 a} = 1 / 3 * {T}_{SW}$$

$${t}_{2 b} = 1 / 6 * {T}_{SW}$$

As with the M odd case, a general solution for arbitrary M being even yields the solution:

$${t}_{1 a} = ( M - 2 ) / ( 2 M ) * {T}_{SW}$$

$${t}_{1 b} = 1 / M * {T}_{SW}$$

$${t}_{2 a} = ( M - 2 ) / ( 2 M ) * {T}_{SW}$$

$${t}_{2 b} = 1 / M * {T}_{SW}$$

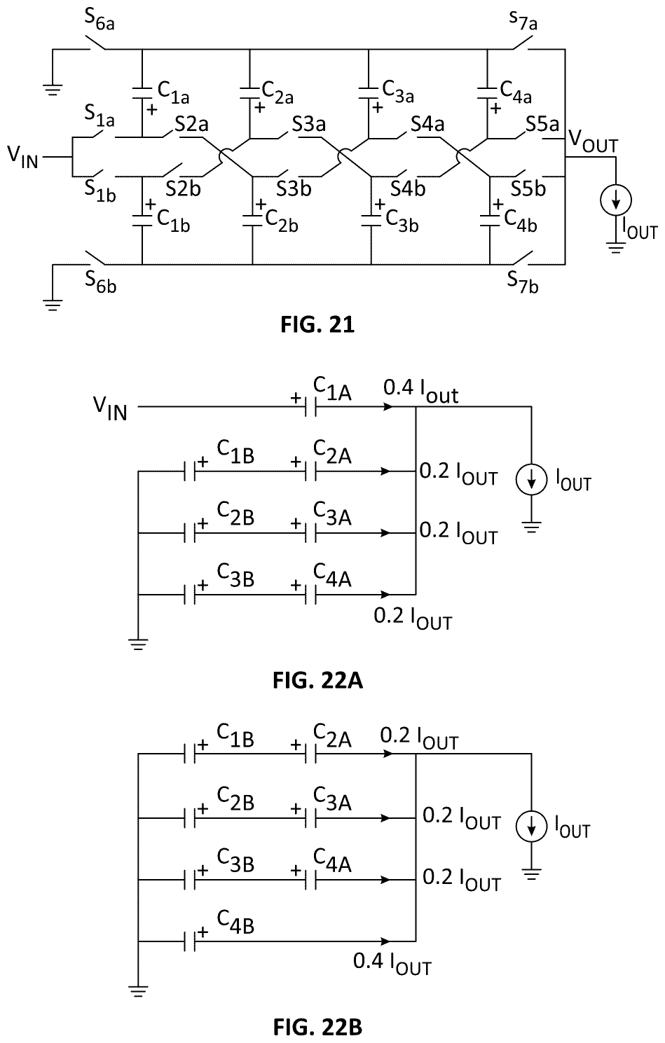

The approach described above is applicable to multi-phase charge pumps. For example, FIG. 21 shows a two-phase M=5 charge pump that includes fourteen switches labeled S₁ₐ to S_{7b} and eight capacitors C₁ₐ to C_{4b}. The configurations for the switches in one possible four-state approach (with states labeled 1a, 1b, 2a, 2) are shown in the table below:

| | Switch | | | | | | | | | | | | | |
|---|---|---|---|---|---|---|---|---|---|---|---|---|---|---|
| State | S₁ₐ | S_{1b} | S₂ₐ | S_{2b} | S₃ₐ | S_{3b} | S₄ₐ | S_{4b} | S₅ₐ | S_{5b} | S₆ₐ | S_{6b} | S₇ₐ | S_{7b} |
| State 1a | 1 | 0 | 0 | 1 | 0 | 1 | 0 | 1 | 0 | 0 | 0 | 1 | 1 | 0 |
| State 1b | 0 | 0 | 0 | 1 | 0 | 1 | 0 | 1 | 0 | 1 | 0 | 1 | 1 | 0 |
| State 2a | 0 | 1 | 1 | 0 | 1 | 0 | 1 | 0 | 0 | 0 | 1 | 0 | 0 | 1 |
| State 2b | 0 | 0 | 1 | 0 | 1 | 0 | 1 | 0 | 1 | 0 | 1 | 0 | 0 | 1 |

FIGS. 22A-B shows the equivalent circuits for states 1a and 1b, respectively. The circuits for states 2a and 2b are equivalent (i.e., interchanging the “a” and “b” elements of the circuit). Applying the charge balance constraints for this circuit yields the state occupancy times of 0.25*T_{SW} for each of the four states.

$${t}_{1 a} = {t}_{2 a} = 0.25 * {T}_{SW}$$

$${t}_{1 b} = {t}_{2 b} = 0.25 * {T}_{SW}$$

Note that in this example, the input current from V_{IN} is zero during states 1b and 2b and non-zero during states 1a and 2a at an average 0.4*Ī_{OUT}, yielding an average input current of 0.2*Ī_{OUT}=Ī_{OUT}/M as expected.

Referring to FIG. 21, a parallel arrangement of two sections as shown in FIG. 15 in parallel. The timing of each section is 90° out of phase, such that one section has the switch configuration of state la while the other section has the switch configuration of state 1b, and so forth. Note that in this parallel arrangement, the average input current is 0.2*Ī_{OUT}=Ī_{OUT}/M in each cycle of operation.

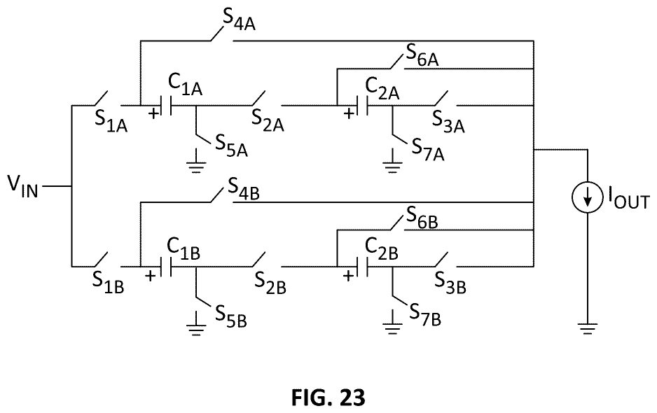

The approaches described above are applicable to a wide range of charge pump topologies. As a further example, an FIG. 23 shows a M=3 two-phase series-parallel circuit that includes fourteen switches labeled S₁ₐ to S_{7b} and four capacitors C_{1A} to C_{2B}. The configuration of switches in the four states is shown in tabular form as:

| | Switch | | | | | | | | | | | | | |
|---|---|---|---|---|---|---|---|---|---|---|---|---|---|---|
| State | S₁ₐ | S_{1b} | S₂ₐ | S_{2b} | S₃ₐ | S_{3b} | S₄ₐ | S_{4b} | S₅ₐ | S_{5b} | S₆ₐ | S_{6b} | S₇ₐ | S_{7b} |
| State 1a | 1 | 0 | 1 | 0 | 1 | 0 | 0 | 1 | 0 | 1 | 0 | 0 | 0 | 0 |
| State 1b | 1 | 0 | 1 | 0 | 1 | 0 | 0 | 0 | 0 | 0 | 0 | 1 | 0 | 1 |
| State 2a | 0 | 1 | 0 | 1 | 0 | 1 | 1 | 0 | 1 | 0 | 0 | 0 | 0 | 0 |
| State 2b | 0 | 1 | 0 | 1 | 0 | 1 | 0 | 0 | 0 | 0 | 1 | 0 | 1 | 0 |

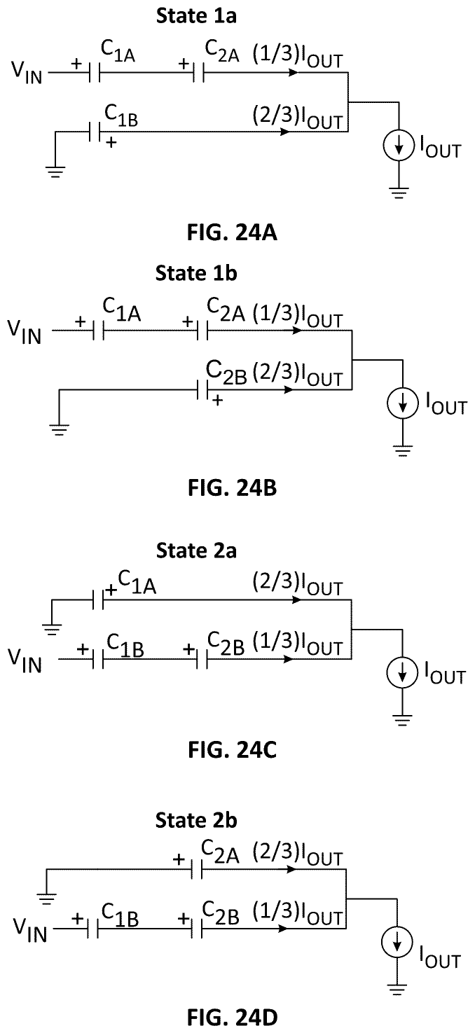

Equivalent circuits for the four states are shown in FIGS. 24A-D. Charge balance is achieved with a state duration of 0.25*T_{SW} for each state, yielding an average input current from VIN in each state and cycle of (1/3)*Ī_{OUT}.

In the analysis above, the average current Ī_{OUT} is assume to be the same during all state occupancy intervals, therefore, the charge transfers are proportional to tₖ*Ī_{OUT}. In an alternative approach, the average output current may be controlled to be different for different states so that the charge transfers in state k are proportional to tₖ*Ī_{OUT,k} where both the duration tₖ and the average current Ī_{OUT,k} are determined according to the constraint equations. In some examples, the state durations may be further (fully or partially) constrained for other considerations, for example, to avoid short duration states which might cause EMI (electro-magnetic interference). An example, where such variable and periodic control of output current may be effective is when driving one or more LEDs (light emitting diode) in series or in parallel, where the variation in current does not appreciably cause perceptible variation in light output.

The approach described above can be applied to the two-phase M=5 charge pump of FIG. 21. One possible four-state approach, with states labeled 1a, 1b, 2a, 2b, configuration of switches in the four states is shown in tabular form as:

| | Switch | | | | | | | | | | | | | |
|---|---|---|---|---|---|---|---|---|---|---|---|---|---|---|
| State | S₁ₐ | S_{1b} | S₂ₐ | S_{2b} | S₃ₐ | S_{3b} | S₄ₐ | S_{4b} | S₅ₐ | S_{5b} | S₆ₐ | S_{6b} | S₇ₐ | S_{7b} |
| State 1a | 1 | 0 | 0 | 0 | 0 | 0 | 0 | 0 | 0 | 1 | 0 | 1 | 1 | 0 |
| State 1b | 0 | 0 | 0 | 1 | 0 | 1 | 0 | 1 | 0 | 0 | 0 | 1 | 1 | 0 |
| State 2a | 0 | 1 | 0 | 0 | 0 | 0 | 0 | 0 | 1 | 0 | 1 | 0 | 0 | 1 |
| State 2b | 0 | 0 | 1 | 0 | 1 | 0 | 1 | 0 | 0 | 0 | 1 | 0 | 0 | 1 |

With state occupancy times of 0.25*T_{SW} for each of the four states, it becomes necessary to apply a current skew, I_{SKEW}, to the output load in each state to achieve charge balance over a cycle of the four states. In this example, a negative current skew of 0.2*I_{OUT} during states 1a and 1b, and a positive current skew of 0.2*I_{OUT} during states 1a and 1b will achieve charge balance in all capacitors over a cycle, where the average output current across each cycle of four states is I_{OUT}. In other words, the output load current during states 1a and 2a is 0.8*I_{OUT} and the output load current during states 1a and 1b is 1.2*I_{OUT}. The magnitude of the applied current skew is the same in all four states, but the polarity of the current skew changes back and forth between positive and negative from one state to the next. For a two-phase charge pump with this four-state approach and 0.25*T_{SW} state occupancy times, a general solution for arbitrary M yields the following solution for the magnitude of the applied current skew, I_{SKEW}.

$${I}_{SKEW} = \vert \frac{4 - M}{M} \vert {I}_{OUT}$$

It should be understood that the description above focuses on analysis of idealized circuits with ideal switches, ideal current and voltage sources, and resistance-free circuit paths. In practice, switches are implemented, for instance, with transistors, which generally exhibit internal resistance and capacitive characteristics. The output current source may be implemented using an inductor such that during the part of the duty cycle modeled as a constant current, the current in fact increases or decreases as energy is transferred from the charge pump to the inductor. Physical capacitors may have slightly different capacitances, and therefore the ideal analysis for charge balancing may not be exactly correct. Nevertheless, the approach presented above is applicable to non-ideal implementations of the approach, either exactly, or accounting for the non-ideal nature of the circuit for example, determining the state times to achieve charge balance in a real rather than an ideal circuit, for example, using numerical circuit simulation techniques.

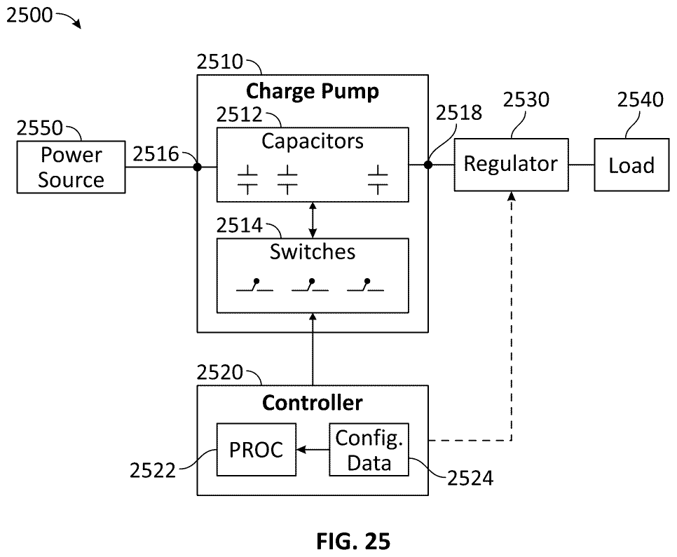

Implementations of a charge pump controlled according to one or more of the approaches described above may use a controller that is configured to follow a state sequence as described and to set the switches accordingly. Referring to FIG. 25, an example of a power control system 2500 includes a charge pump 2510 coupled to a controller 2520. The charge pump 2510 includes capacitors 2512 and switches 2514. A terminal 2516 (e.g., a high voltage terminal) couples the charge pump to a power source 2550, for example, to a voltage source (e.g., at 25 volts). Another terminal 2518 couples the charge pump to a regulator 2530. A controller 2520, which includes a programmable processor 2522 configured with configuration data 2524 (and/or processor instructions), which impart functionality on the controller. In some examples, the controller also controls the regulator, for example, to maintain a common underlying clocking rate for both the charge pump and the regulator (e.g., switching the regulator at a multiple 2×, 4×, 10×, 100×, etc. of the cycle frequency of the charge pump). In some implementations, the controller is integrated in whole or in part in an integrated device that includes at least some of the switching devices (e.g., transistors). It should be understood that in practice, the devices are not ideal, for example, with the capacitors not necessarily having identical capacitances, and with non-zero resistances in circuit paths and through transistor switches in the charge pump. In some examples, the controller controls the switches according to the idealized analysis. In other examples, the effect of non-idealized characteristics are taken into account in determining the state durations, for example, by explicit circuit analysis (e.g., simulation) or adaptively by adjusting the relative state durations to achieve charge balance during state cycles. In some examples, the controller is software configurable, for example, allowing specific state timing to be configured after the device is fabricated. In some examples, the controller is fully or at least partially implemented in application-specific logic that is specified with the other circuit components of the device.

Having described the invention, and a preferred embodiment thereof, what is claimed as new, and secured by letters patent is:

1. An apparatus comprising:
a charge pump circuit comprising a plurality of switch elements including at least some switch elements configured to couple terminals of at least some of a plurality of capacitor elements to permit charge transfer between the capacitors and at least some switch elements configured to couple terminals of at least some of the plurality of capacitor elements to a high voltage terminal or a low voltage terminal; and
a controller circuit coupled to the switch elements and configured to cycle the switch elements through a sequence of states, each state defining a corresponding configuration of the switch elements, at least three of said states defining different configurations of the switch elements permitting charge transfer between at least some of the capacitors or between at least one capacitor and the high voltage or the low voltage terminal, wherein the configured cycle of states provides a voltage conversion between the high voltage terminal and the low voltage terminal.
